(19) United States
(12) Patent Application Publication
(10) Pub. No.: US 2023/0351197 A1
(43) Pub. Date: Nov. 2, 2023

(54) LEARNING ACTIVE TACTILE PERCEPTION THROUGH BELIEF-SPACE CONTROL

(71) Applicant: SAMSUNG ELECTRONICS CO,LTD., Suwon-si (KR)

(72) Inventors: Jean-Francois TREMBLAY, Montreal (CA); Francois Robert HOGAN, St.Jean-Sur-Richelieu (CA); David Paul MEGER, Ottawa (CA); Gregory Lewis DUDEK, Westmount (CA)

(73) Assignee: SAMSUNG ELECTRONICS CO,LTD., Suwon-si (KR)

(21) Appl. No.: 18/141,031

(22) Filed: Apr. 28, 2023

Related U.S. Application Data
(60) Provisional application No. 63/336,921, filed on Apr. 29, 2022.

(51) Int. Cl. G06N 3/09; G06N 3/045; B25J 13/08; B25J 9/16

(52) U.S. Cl. CPC G06N 3/09; G06N 3/045; B25J 13/085; B25J 9/161

(57) ABSTRACT

Provided are a robotic device and a method for identifying a property of an object. The method may include obtaining sensor data from at least one sensor, identifying, using the sensor data, a property of interest of an object, training, using one or more neural networks, a model to predict the uncertainty about the next state of the object based on an action, and based on identifying the uncertainty about the next state of the object, controlling a movement of a robotic element to perform the action.

### CROSS-REFERENCE TO RELATED APPLICATION

This application is based on and claims priority under 35 U.S.C. § 119 from U.S. Provisional Application No. 63/336,921 filed on Apr. 29, 2022, in the U.S. Patent & Trademark Office, the disclosure of which is incorporated by reference herein in its entirety.

### BACKGROUND

### 1. Field

The disclosure relates to a robotic device and a method for controlling a robotic device to approach an unidentified object and autonomously identify one or more properties of the object without human interaction by learning active tactile perception through belief-space control.

### 2. Description of Related Art

Robots operating in an open world may encounter many unknown and/or unidentified objects and may be expected to manipulate them effectively. To achieve this, it may be useful for robots to infer the physical properties of unknown objects through physical interactions. The ability to measure these properties online may be used for robots to operate robustly in the real-world with open-ended object categories. A human might identify properties of an object by performing exploratory procedures such as pressing on objects to test for object hardness and lifting objects to estimate object mass. These exploratory procedures may be challenging to hand-engineer and may vary based on the type of object.

### SUMMARY

Provided are a robotic device and a method for controlling a robotic device to approach an unidentified object and autonomously identify one or more properties of the object, without human interaction, by learning active tactile perception through belief-space control.

Additional aspects will be set forth in part in the description which follows and, in part, will be apparent from the description, or may be learned by practice of the presented embodiments.

In accordance with an aspect of the disclosure, there is provided a method for identifying a property of an object including: obtaining sensor data from at least one sensor; identifying, using the sensor data, a property of interest of an object; training, using one or more neural networks, a model to predict a next uncertainty about a state of the object based on an action; and based on identifying the next uncertainty about the state of the object, controlling a movement of a robotic element to perform the action.

The training may include repeatedly performing the training until a convergence is identified based on a reduced training error.

The training may include minimizing a training loss by approximating a belief state.

The action may include pressing the object with the robotic element and obtaining readings from the at least one sensor.

The identifying the property of interest of the object may include pressing the object with the robotic element at multiple points of the object and obtaining readings from the at least one sensor.

The identifying the property of interest may include lifting the object with the robotic element.

The model may include a dynamics model and an observation model.

According to an aspect of the disclosure, there is provided an electronic device for identifying a property of an object including: at least memory storing instructions; and at least one processor configured to execute the instructions to: obtain sensor data from at least one sensor; identify, using the sensor data, a property of interest of an object; train, using one or more neural networks, a model to predict a next state and observation of the system based on an action; and based on identifying the next uncertainty about the object property of interest, control a movement of a robotic element to perform the action.

The at least one processor may be further configured to repeatedly perform the training until a convergence is identified based on a reduced training error.

The at least one processor may be further configured to minimize a training loss by approximating a belief state.

The action may include pressing the object with the robotic element and obtaining readings from the at least one sensor.

The at least one processor may be further configured to identify the property of interest of the object by pressing the object with the robotic element at multiple points of the object and obtaining readings from the at least one sensor.

The at least one processor may be further configured to identify the property of interest by lifting the object with the robotic element.

The model may include a dynamics model and an observation model.

According to an aspect of the disclosure, there is provided a non-transitory computer readable storage medium that stores instructions to be executed by at least one processor to perform a method for identifying a property of an object including: obtaining sensor data from at least one sensor; identifying, using the sensor data, a property of interest of an object; training, using one or more neural networks, a model to predict a next state of the object based on an action; and based on identifying the next state of the object, controlling a movement of a robotic element to perform the action.

The training may include repeatedly performing the training until a convergence is identified based on a reduced training error.

The training may include minimizing a training loss by approximating a belief state.

The action may include pressing the object with the robotic element and obtaining readings from the at least one sensor.

The identifying the property of interest of the object may include pressing the object with the robotic element at multiple points of the object and obtaining readings from the at least one sensor.

The identifying the property of interest comprises lifting the object with the robotic element.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a diagram illustrating an example robotic device and actions that a robotic device may perform;

FIG. 2 is a block diagram illustrating an example process of a training phase for estimating one or more object properties, according to an embodiment;

FIG. 3 is a block diagram illustrating an example process of a deployment phase for estimating one or more object properties, according to an embodiment;

FIG. 4 is a diagram illustrating models that map a current state and a current action with a resulting state, according to one or more embodiments;

FIGS. 5A, 5B, 5C, and 5D are block diagrams illustrating a state and property estimator including dynamics modeling and sensor modeling, according to one or more embodiments;

FIG. 6 illustrates a process of minimizing a training loss used during a training procedure of a learning-based state estimator, according to an embodiment;

FIG. 7A illustrates a block diagram of an uncertainty minimizing controller, according to an embodiment;

FIG. 7B is a block diagram illustrating a process of estimating future uncertainty by leveraging a generative dynamics model and an observation model, according to an embodiment;

FIG. 8 is a flowchart illustrating an example process for identifying a property of interest of an object, according to an embodiment; and

FIG. 9 is a diagram of components of one or more electronic devices, according to one or more embodiments.

### DETAILED DESCRIPTION

Embodiments of the present disclosure provide a robotic device and a method for controlling a robotic device for autonomously identifying one or more properties of an object.

As the disclosure allows for various changes and numerous examples, one or more embodiments will be illustrated in the drawings and described in detail in the written description. However, this is not intended to limit the disclosure to modes of practice, and it will be understood that all changes, equivalents, and substitutes that do not depart from the spirit and technical scope of the disclosure are encompassed in the disclosure.

In the description of the embodiments, detailed explanations of related art are omitted when it is deemed that they may unnecessarily obscure the essence of the disclosure. Also, numbers (for example, a first, a second, and the like) used in the description of the specification are identifier codes for distinguishing one element from another.

Also, in the present specification, it will be understood that when elements are “connected” or “coupled” to each other, the elements may be directly connected or coupled to each other, but may alternatively be connected or coupled to each other with an intervening element therebetween, unless specified otherwise.

Throughout the disclosure, it should be understood that when an element is referred to as “including” an element, the element may further include another element, rather than excluding the other element, unless mentioned otherwise.

In the present specification, regarding an element represented as a “unit,” “processor,” “controller,” or a “module,” two or more elements may be combined into one element or one element may be divided into two or more elements according to subdivided functions. This may be implemented by hardware, software, or a combination of hardware and software. In addition, each element described hereinafter may additionally perform some or all of functions performed by another element, in addition to main functions of itself, and some of the main functions of each element may be performed entirely by another component.

Throughout the disclosure, the expression “at least one of a, b or c” indicates only a, only b, only c, both a and b, both a and c, both b and c, all of a, b, and c, or variations thereof.

Embodiments may relate to a robotic device and a method for controlling a robotic device for autonomously identifying one or more properties of an object.

According to one or more embodiments, a method for autonomously learning active tactile perception policies, by learning a generative world model leveraging a differentiable Bayesian filtering algorithm, and designing an information-gathering model predictive controller is described herein.

According to one or more embodiments, exploratory procedures are learned to estimate object properties through belief-space control. Using a combination of 1) learning based state-estimation to infer the property from a sequence of observations and actions, and 2) information-gathering model-predictive control (MPC), a robot may learn to execute actions that are informative about the property of interest and to discover exploratory procedure without any human priors. According to one or more embodiments, a method may use three simulated tasks: mass estimation, height estimation and toppling height estimation.

For example, a mass of a cube may be estimated. A cube has constant size and friction coefficient, but its mass changes randomly between 1 kg and 2 kg in between episodes. A robot should be able to push it and extract mass from the force and torque readings generated by the push. A height of an object may also be estimated. For example, a force torque sensor, in this scenario, may act as a contact detector. An expected behavior may be to come down until contact is made, at which point the height may be extracted from forward kinematics. A minimum toppling height may also be estimated. A minimum toppling height refers to a height at which an object will topple instead of slide when pushed.

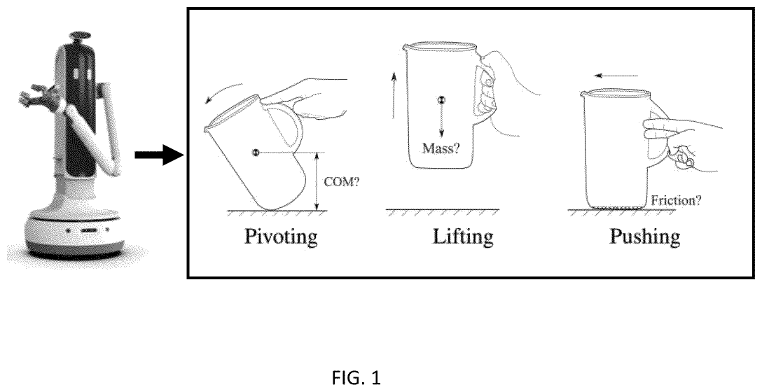

FIG. 1 is a diagram illustrating an example robotic device and actions that a robotic device may perform. As illustrated in FIG. 1, according to an embodiment, a robotic device may perform an action with respect to an object (e.g., pivoting, lifting, pushing, etc.) To perform an action, the robotic device should know one or more properties associated with the object. For example, for performing a pivoting action, a center of mass (COM) of the object should be known. For performing a lifting action, a mass should be known. For performing a pushing operation, a friction should be known. According to an embodiment, a robotic device and method is provided for, without human guidance, identifying and/or learning properties of an unidentified object by performing various actions on the object (e.g., pivoting, pushing, lifting), and for assisting the robotic device with performing future actions on the object based on the learned properties.

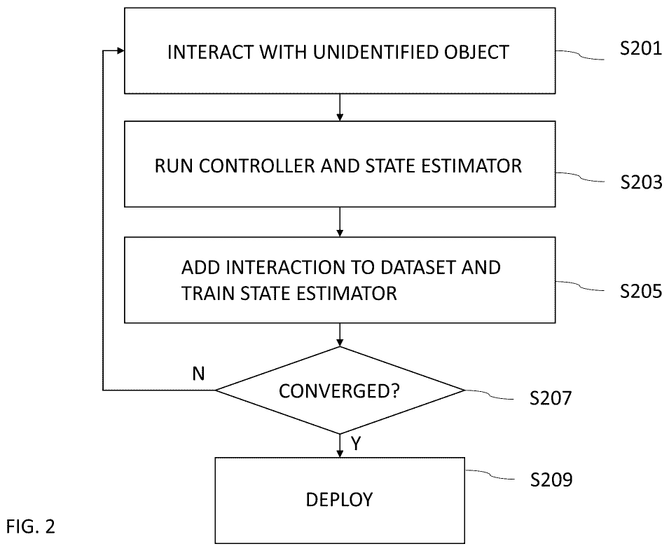

FIG. 2 is a block diagram illustrating an example process of a training phase for estimating one or more object properties, according to an embodiment. At operation S201, the process may include a robotic device interacting with an unidentified object. For example, a robotic device may approach an object and begin a process of identifying at least one property of the object. The robotic device may use a machine learning algorithm, such as supervised learning, to train a machine learning model to identify properties of an object. During a supervised learning portion in a training phase, a property of an object may be provided to the robotic device to allow the robotic device to learn how an object reacts to an object with that property. For example, the mass of an object may be provided to the robotic device to teach the robotic device how an object having the provided mass will react in response to the robotic device performing an action on the object (e.g., pushing, lifting, pivoting, etc.).

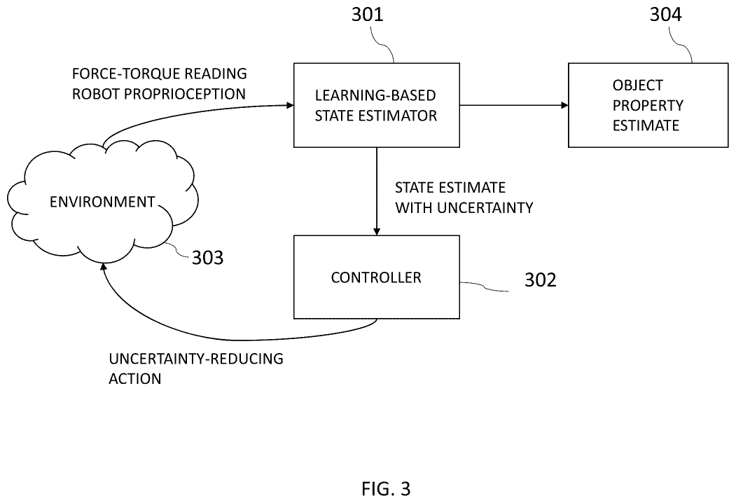

At operation S203, the process may include running a controller and a state estimator. The controller may be an information-gathering model predictive controller. The state estimator evaluates a current state and a current action and predicts a next state based on the current action. A state of a system may refer to elements that are useful for predicting a future of the system. At operation S205, the process may include adding the interaction with the object to a dataset and training the state estimator. According to an embodiment, the training phase may be performed for a fixed number of steps or based on a convergence criterion. For example, at operation S207, it may be determined whether there is a convergence. The determining whether there is a convergence may include comparing a current error value with a known error value. When the current error value is minimized then there is a convergence. If there is a convergence (S207—Y), then the training phase is complete and the deployment process may be initiated (S209), which will be described with respect to FIG. 3 below.

FIG. 3 is a block diagram illustrating an example process of a deployment phase for estimating one or more object properties, according to an embodiment. A learning-based state estimator 301 provides a state estimate with uncertainty to a controller 302. A state of a system may refer to elements that are useful for predicting a future of the system. For example, in a case of a robot pushing an object, the elements useful for predicting a future of a system may be robot joint pose, robot joint velocities, robot joint torques, object pose, object velocity, and object acceleration. An uncertainty-reducing action may be performed. Controller 302 may be an information-gathering model predictive controller. According to an embodiment, an uncertainty-reducing action may be minimizing an uncertainty based on a prediction for a next joint configuration of the robot and a next state of the object based on a performed action.

According to an embodiment, environment 303 may refer to robot pose and velocity, object pose and velocity, object properties, and any properties that describe an environment and are subject to change either during or in between episodes. The force-torque reading proprioception refers to identifying how force-torque sensors react when performing an action on an object (e.g., pressing an object, grabbing an object, etc.) The object property estimate 304 refers to an estimated property as identified by the learning-based state estimator (e.g., mass, height, friction).

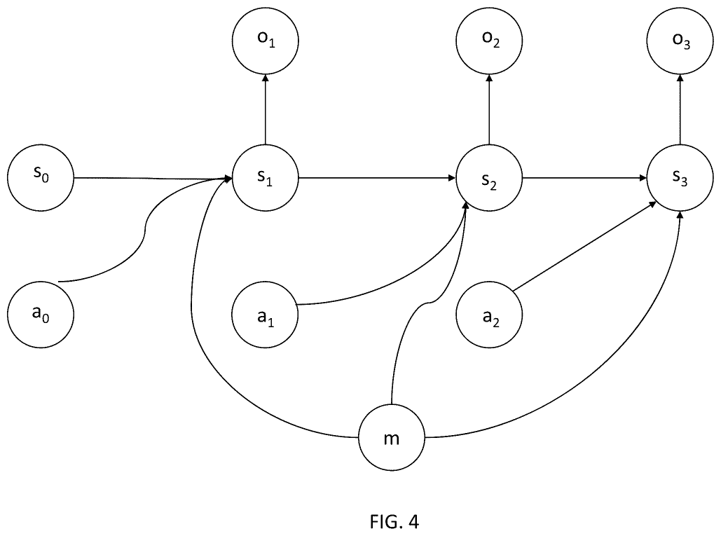

FIG. 4 is a diagram illustrating models that map a current state and a current action (e.g., what a robot intends to do) with a resulting state, according to one or more embodiments. In the diagram s₀ represents a state at time t₀ (e.g., current state), s₁ represents a state at time t₁, s₂ represents a state at time t₂, and s₃ represents a state at time t₃. Similarly, a₀ represents an action at time t₀ (e.g., current action), a₁ represents an action at time t₁, and a₂ represents an action at time t₂. o₁ represents an observation at time t₁, o₂ represents an observation at time t₂, and o₃ represents an observation at time t₃. As described above, s₀ refers to a current state and a₀ refers to a current action, and s₁ refers to a state at time t₁ and a₁ refers to a next action.

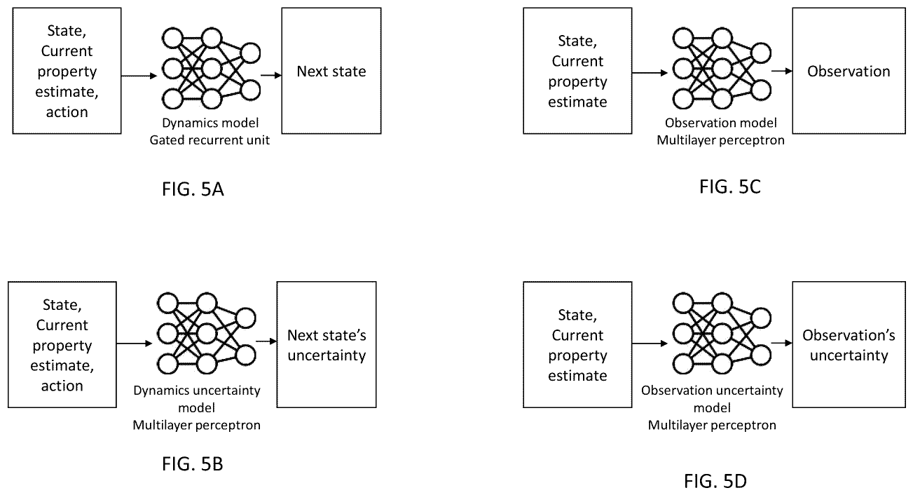

FIGS. 5A, 5B, 5C, and 5D are block diagrams illustrating a state and property estimator including dynamics modeling and sensor modeling, according to one or more embodiments. For example, FIGS. 5A, 5B, 5C, and 5D illustrate a neural network architecture for modeling a system.

FIG. 5A illustrates a block diagram of an example dynamics model using a gated recurrent unit, according to an embodiment. For example, based on a current state, a current property estimate, and a current action, the dynamics model according to an embodiment will identify a next state using a gated recurrent unit. Referring to FIG. 4, the dynamics model illustrated in FIG. 5A maps the current state s₀ and a current action a₀ to a resulting state s₁. The dynamics model may be a trained neural network in which the resulting state s₁ is a learned state.

FIG. 5B illustrates a block diagram of an example dynamics uncertainty model using a multilayer perceptron, according to an embodiment. For example, based on a current state, a current property estimate, and a current action, the dynamics uncertainty model according to an embodiment will identify a next state's uncertainty using a multilayer perceptron. Referring to FIG. 4, the dynamics uncertainty model identifies how much uncertainty there is in going from state s₀ to s₁. For example, based on a current joint configuration of a robot, a current pose of an object, and an action to be performed on the object, the dynamics uncertainty model makes a prediction for the next joint configuration of the robot and the next pose of the object based on the performed action. The uncertainty model also provides an uncertainty estimate for how certain the model is of the next joint configuration of the robot and the next pose of the object.

FIG. 5C illustrates a block diagram of an example observation model using a multilayer perceptron, according to an embodiment. For example, based on a current state and a current property estimate, the observation model according to an embodiment will identify an observation using a multilayer perceptron. Referring to FIG. 4, the model does not have access to the information of state s₁ because the state s₁ is based on learning and/or predicting what a next state (e.g., next joint configuration of robot and next pose of the object will be). The model has access to readings from one or more sensors of the robot joints and/or one or more force-torque sensors of the robot. Thus, the observation model maps the state s₁ to the observed sensor readings (o₁) of the robot.

FIG. 5D illustrates a block diagram of an example observation uncertainty model using a multilayer perceptron. For example, based on a current state and a current property estimate, the observation uncertainty model according to an embodiment will identify an observation's uncertainty using a multilayer perceptron. Referring to FIG. 4, the observation uncertainty model identifies how much noise exists in the observed sensor readings (o₁) of the robot. The noise may be represented by a Gaussian error model.

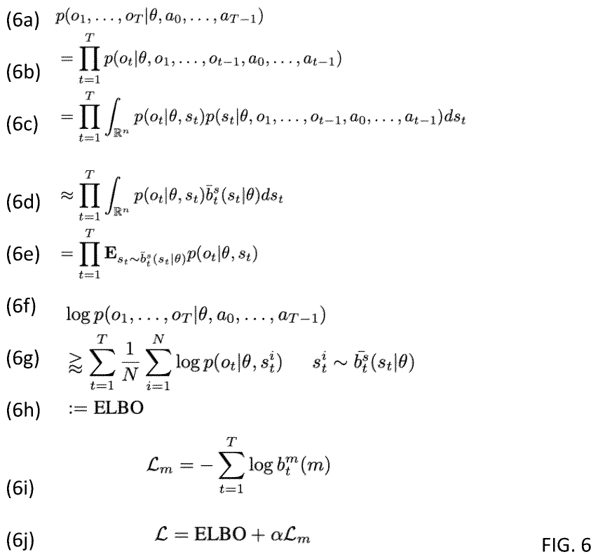

FIG. 6 illustrates a process of minimizing a training loss used during a training procedure of a learning-based state estimator, according to an embodiment. Expressions 6a through 6j provide examples of how the learning-based state estimator 301 of FIG. 3 accounts for training loss. For example, in a transition from expression 6c to 6d, the variables p(st|θ, o₁, . . . , oₜ₋₁, a₀, . . . , aₜ₋₁) are substituted for an approximate belief from an extended Kalman filter (EKF). ELBO refers to an evidence lower bound. Expression 6j refers to the final training loss and is a combination of previous losses from expressions 6h and 6i. Expression 6j optimizes the neural networks described in FIGS. 5A to 5D.

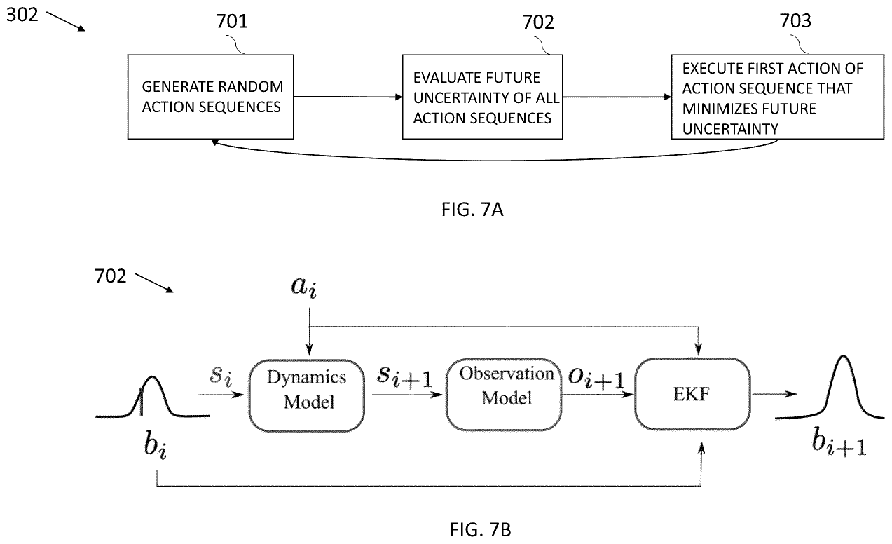

FIG. 7A illustrates a block diagram of an uncertainty minimizing controller 302, according to an embodiment. At operation 701, the uncertainty minimizing controller may generate many random action sequences (e.g., thousands of action sequences such as pushing on an object, etc.) of the robot using a neural network. At operation 702, the controller, using a neural network, may evaluate a future uncertainty for all action sequences of operation 701. At operation 703, the controller identifies which action of the action sequence minimizes future uncertainty, and controls the robot to perform that action. The controller of the robotic device is continuously and autonomously re-evaluating the actions to minimize future uncertainty.

FIG. 7B is a block diagram illustrating a process of estimating future uncertainty by leveraging a generative dynamics model and an observation model, according to an embodiment. As illustrated in FIG. 7B, the process is estimating a future state based on a current state. For example, will uncertainty be reduced by performing the process. bᵢ refers to a belief which is a Gaussian distribution. A sample state (sᵢ) may be taken from the Gaussian distribution and may be provided to a dynamics model. The dynamics model may take sᵢ as input and output a future state sᵢ₊₁. The sᵢ₊₁ may be provided to an observation model, which may output a future observation oᵢ₊₁. Thus, a current belief bᵢ, a current action aᵢ, and a future observation oᵢ₊₁ may be provided to an extended Kalman filter (EKF). The EKF may output a future estimate of an uncertainty about the belief state bᵢ₊₁.

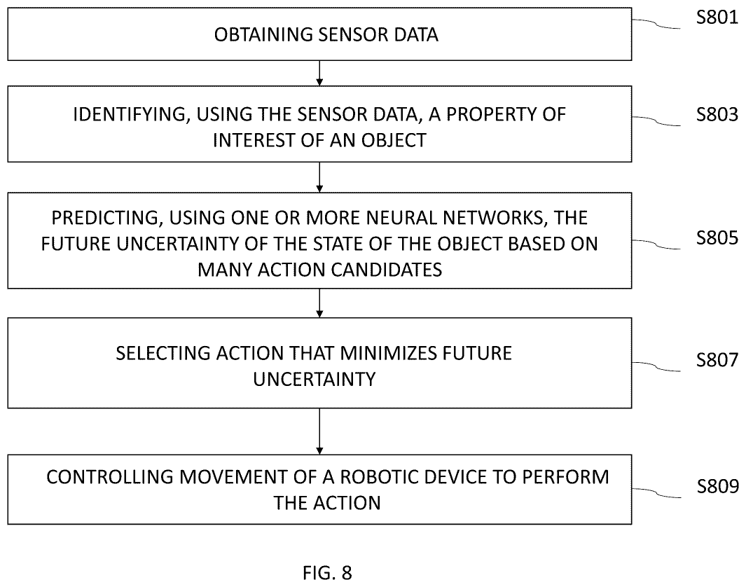

FIG. 8 is a flowchart illustrating an example process for identifying a property of interest of an object, according to an embodiment. In operation S801, the process may include obtaining sensor data. The sensor data may include sensor data from force-torque sensors in the robotic element and/or one or more sensors in the robotic element's joints. In operation S803, the process may include identifying, using the obtained sensor data, a property of interest of an object. According to an embodiment, the property of interest of the object may be provided as a user input to the robot or it may be determined autonomously by the robot. The identifying the property of interest of the object comprises pressing the object with the robotic element at multiple points of the object and/or lifting the object with the robotic element. According to an embodiment, the model may include a dynamics model and an observation model. In operation S805, the process may include predicting, using one or more neural networks, the future uncertainty of the state of the object based on many action candidates. For example the process may include identifying a model to predict a next state and observation of the system based on one or more actions. According to an embodiment, the training may include repeatedly performing the training until a convergence is identified based on a reduced training error. The training may include minimizing a training loss (e.g., novel loss) by approximating a belief state. The training loss may be a mathematical function derived (or identified) by a person, and the computer may optimize the neural networks using that loss. In operation S807, the process may include selecting the action that minimizes future uncertainty. In operation S809, the process may include controlling movement of a robotic device to perform an action. The action may include pressing on the object, lifting the object, pivoting the object, etc. However, actions are not limited to this.

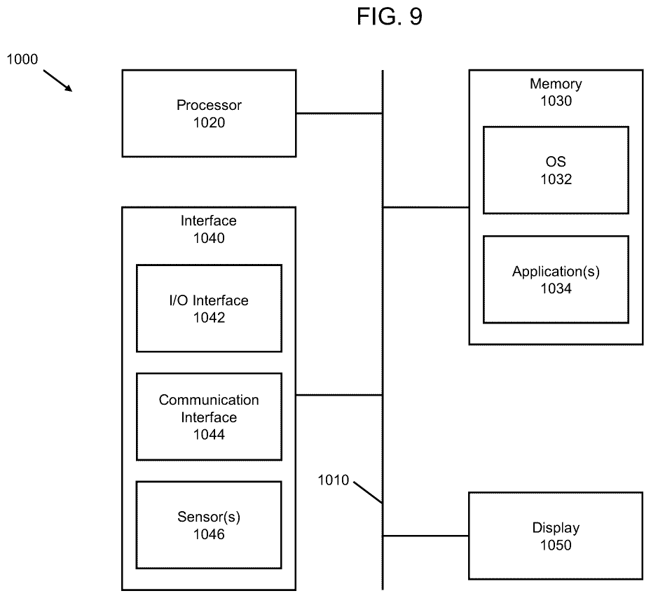

FIG. 9 is a diagram of components of one or more electronic devices, according to an embodiment. An electronic device 1000 in FIG. 9 may correspond to a robotic device.

FIG. 9 is for illustration only, and other embodiments of the electronic device 1000 could be used without departing from the scope of this disclosure. For example, the electronic device 1000 may correspond to a client device or a server.

The electronic device 1000 includes a bus 1010, a processor 1020, a memory 1030, an interface 1040, and a display 1050.

The bus 1010 includes a circuit for connecting the components 1020 to 1050 with one another. The bus 1010 functions as a communication system for transferring data between the components 1020 to 1050 or between electronic devices.

The processor 1020 includes one or more of a central processing unit (CPU), a graphics processor unit (GPU), an accelerated processing unit (APU), a many integrated core (MIC), a field-programmable gate array (FPGA), or a digital signal processor (DSP). The processor 1020 is able to perform control of any one or any combination of the other components of the electronic device 1000, and/or perform an operation or data processing relating to communication. For example, the processor 1020 may perform the methods illustrated in FIGS. 2, 3, 7A, 7B, and 8. The processor 1020 executes one or more programs stored in the memory 1030.

The memory 1030 may include a volatile and/or non-volatile memory. The memory 1030 stores information, such as one or more of commands, data, programs (one or more instructions), applications 1034, etc., which are related to at least one other component of the electronic device 1000 and for driving and controlling the electronic device 1000. For example, commands and/or data may formulate an operating system (OS) 1032. Information stored in the memory 1030 may be executed by the processor 1020.

The applications 1034 include the above-discussed embodiments. These functions can be performed by a single application or by multiple applications that each carry out one or more of these functions. For example, the applications 1034 may include an artificial intelligence (AI) model for performing the methods illustrated in FIGS. 2, 3, 7A, 7B, and 8.

The display 1050 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 1050 can also be a depth- aware display, such as a multi-focal display. The display 1050 is able to present, for example, various contents, such as text, images, videos, icons, and symbols.

The interface 1040 includes input/output (I/O) interface 1042, communication interface 1044, and/or one or more sensors 1046. The I/O interface 1042 serves as an interface that can, for example, transfer commands and/or data between a user and/or other external devices and other component(s) of the electronic device 1000.

The communication interface 1044 may enable communication between the electronic device 1000 and other external devices, via a wired connection, a wireless connection, or a combination of wired and wireless connections. The communication interface 1044 may permit the electronic device 1000 to receive information from another device and/or provide information to another device. For example, the communication interface 1044 may include an Ethernet interface, an optical interface, a coaxial interface, an infrared interface, a radio frequency (RF) interface, a universal serial bus (USB) interface, a Wi-Fi interface, a cellular network interface, or the like. The communication interface 1044 may receive videos and/or video frames from an external device, such as a server.

The sensor(s) 1046 of the interface 1040 can meter a physical quantity or detect an activation state of the electronic device 1000 and convert metered or detected information into an electrical signal. For example, the sensor(s) 1046 can include one or more cameras or other imaging sensors for capturing images of scenes. The sensor(s) 1046 can also include any one or any combination of a microphone, a keyboard, a mouse, and one or more buttons for touch input. The sensor(s) 1046 can further include an inertial measurement unit. The sensor(s) 1046 can further include force-torque sensors. In addition, the sensor(s) 1046 can include a control circuit for controlling at least one of the sensors included herein. Any of these sensor(s) 1046 can be located within or coupled to the electronic device 1000. The sensor(s) 1046 may receive a text and/or a voice signal that contains one or more queries.

According to one or more embodiments, provided is a method for autonomously learning active tactile perception policies, by learning a generative world model leveraging a differentiable Bayesian filtering algorithm, and designing an information-gathering model predictive controller.

While the embodiments of the disclosure have been described with reference to the figures, it will be understood by those of ordinary skill in the art that various changes in form and details may be made therein without departing from the spirit and scope as defined by the following claims.

What is claimed is:

1. A method for identifying a property of an object, the method comprising:
obtaining sensor data from at least one sensor;
identifying, using the sensor data, a property of interest of an object;
training, using one or more neural networks, a model to predict a next uncertainty about a state of the object based on an action; and
based on identifying the next uncertainty about the state of the object, controlling a movement of a robotic element to perform the action.

2. The method of claim 1, wherein the training comprises repeatedly performing the training until a convergence is identified based on a reduced training error.

3. The method of claim 1, wherein the training comprises minimizing a training loss by approximating a belief state.

4. The method of claim 1, wherein the action comprises pressing the object with the robotic element and obtaining readings from the at least one sensor.

5. The method of claim 1, wherein the identifying the property of interest of the object comprises pressing the object with the robotic element at multiple points of the object and obtaining readings from the at least one sensor.

6. The method of claim 1, wherein the identifying the property of interest comprises lifting the object with the robotic element.

7. The method of claim 1, wherein the model comprises a dynamics model and an observation model.

8. An electronic device for identifying a property of an object, the electronic device comprising:
at least memory storing instructions; and
at least one processor configured to execute the instructions to:
obtain sensor data from at least one sensor;
identify, using the sensor data, a property of interest of an object;
train, using one or more neural networks, a model to predict a next uncertainty about a state of the object based on an action; and
based on identifying the next uncertainty about the state of the object, control a movement of a robotic element to perform the action.

9. The electronic device of claim 8, wherein the at least one processor is further configured to repeatedly perform the training until a convergence is identified based on a reduced training error.

10. The electronic device of claim 8, wherein the at least one processor is further configured to minimize a training loss by approximating a belief state.

11. The electronic device of claim 8, wherein the action comprises pressing the object with the robotic element and obtain readings from the at least one sensor. JF: same comment as above From Andrew: see above comments

12. The electronic device of claim 8, wherein the at least one processor is further configured to identify the property of interest of the object by pressing the object with the robotic element at multiple points of the object and obtaining readings from the at least one sensor.

13. The electronic device of claim 8, wherein the at least one processor is further configured to identify the property of interest by lifting the object with the robotic element.

14. The electronic device of claim 8, wherein the model comprises a dynamics model and an observation model.

15. A non-transitory computer readable storage medium that stores instructions to be executed by at least one processor to perform a method for identifying a property of an object, the method comprising:
obtaining sensor data from at least one sensor;
identifying, using the sensor data, a property of interest of an object;
training, using one or more neural networks, a model to predict a next uncertainty about a state of the object based on an action; and
based on identifying the next uncertainty about the state of the object, controlling a movement of a robotic element to perform the action.

16. The non-transitory computer readable storage medium of claim 15, wherein the training comprises repeatedly performing the training until a convergence is identified based on a reduced training error.

17. The non-transitory computer readable storage medium of claim 15, wherein the training comprises minimizing a training loss by approximating a belief state.

18. The non-transitory computer readable storage medium of claim 15, wherein the action comprises pressing the object with the robotic element and obtaining readings from the at least one sensor.

19. The non-transitory computer readable storage medium of claim 15, wherein the identifying the property of interest of the object comprises pressing the object with the robotic element at multiple points of the object and obtaining readings from the at least one sensor.

20. The non-transitory computer readable storage medium of claim 15, wherein the identifying the property of interest comprises lifting the object with the robotic element.
